(19) United States
(12) Patent Application Publication
(10) Pub. No.: US 2025/0071640 A1
(43) Pub. Date: Feb. 27, 2025

(54) DIRECT-TO-INDIRECT PATH SWITCH WITH INDICATION THAT SOURCE CELL IS THE TARGET CELL

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/726,188

(22) PCT Filed: Feb. 9, 2023
(86) PCT No.: PCT/US2023/012672

§ 371 Date: Jul. 2, 2024

Related U.S. Application Data
(60) Provisional application No. 63/308,862, filed on Feb. 10, 2022.

(51) Int. Cl. H04W 36/08; H04W 8/00; H04W 76/20; H04W 76/30; H04W 92/18

(52) U.S. Cl. CPC H04W 36/08; H04W 8/005; H04W 76/20; H04W 76/30; H04W 92/18

(57) ABSTRACT

In the examples described herein, abase station transmits, to a remote UE device over a direct Uu communication link, an RRC Reconfiguration Message with Sync identifying a target relay UE device and explicitly or implicitly identifying a cell for reselection by the target relay UE device. The identified cell is provided by the base station, and the remote UE device is connected to the cell. The remote UE device transmits, to the target relay UE device over a PCS communication link, a PC5-RRC Message indicating the identified cell is the target cell. In response to receiving the PC5-RRC Message, the target relay UE device performs a cell reselection procedure that prioritizes the identified cell.

### CLAIM OF PRIORITY

The present application claims priority to Provisional Application No. 63/308,862, entitled “INTER-CELL SERVICE CONTINUITY,” docket number TPRO 00368 US, filed Feb. 10, 2022, which is assigned to the assignee hereof and hereby expressly incorporated by reference in its entirety.

### RELATED APPLICATIONS

This application is related to PCT Patent Application entitled “INTER-CELL SERVICE CONTINUITY”, docket number TUTL 00368B PC, filed concurrently with this application, assigned to the assignee hereof, and hereby expressly incorporated by reference in its entirety.

### FIELD

This invention generally relates to wireless communications and more particularly to transitioning a wireless communication device from direct to indirect communication with a base station.

### BACKGROUND

Sidelink relaying functionality allows a remote user equipment (UE) device that is out-of-coverage (OoC) to connect with the gNB or base station via a relay UE device.

### SUMMARY

In the examples described herein, a base station transmits, to a remote UE device over a direct Uu communication link, a Radio Resource Control (RRC) Reconfiguration Message with Sync identifying a target relay UE device and explicitly or implicitly identifying a cell for reselection by the target relay UE device. The identified cell is provided by the base station, and the remote UE device is connected to the cell. The remote UE device transmits, to the target relay UE device over a PC5 communication link, a PC5-RRC Message indicating the identified cell is the target cell. In response to receiving the PC5-RRC Message, the target relay UE device performs a cell reselection procedure that prioritizes the identified cell.

### BRIEF DESCRIPTION OF THE DRAWINGS

FIG. 1A is a block diagram of an example of a system in which a remote user equipment (UE) device is directly communicating with a base station.

FIG. 1B is a block diagram of an example of the system of FIG. 1A in which the remote UE device has transitioned to indirectly communicating with the base station via a relay UE device.

FIG. 2A is a block diagram of an example of the base station shown in FIGS. 1A and 1B.

FIG. 2B is a block diagram of an example of the user equipment devices shown in FIGS. 1A and 1B.

FIG. 3 is a flow chart of an example of a method of managing path switching from direct to indirect communication links.

FIG. 4 is a flow chart of an example of a method performed at a remote UE device of managing path switching from direct to indirect communication links.

FIG. 5 is a flow chart of an example of a method performed at a relay UE device of managing path switching from direct to indirect communication links.

### DETAILED DESCRIPTION

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D).

In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying, and the relay UE device establishes a communication path between the remote UE and a base station (gNB) or cell. In some situations, for example, the UE device may be out of the service area of the base station, and the relay UE device provides a communication link routed from such an out-of-coverage (OoC) UE device through the relay UE device to the base station. Where the destination device is another UE device (target UE device), the relaying functionality is typically referred to as UE-to-UE (U2U) relaying.

Thus, sidelink relaying functionality allows a remote UE that is out-of-coverage (OoC) to connect with the gNB or base station via a relay UE device. With UE-to-Network (U2N) relaying, the relay UE needs to be in coverage of a cell and connected to the gNB. The relayed connection from the remote UE device to the base station (gNB) includes (1) a PC5 link (sidelink) between the remote UE device and the relay UE device, and optionally (2) a direct communication link (e.g., Uu link) between the relay UE device and the gNB.

The communication link between a base station and a remote UE device (not involving a relay UE device) through a Uu link is often referred to as a direct link or a direct path. Where the remote UE device is connected to the base station through a relay UE device, the communication link is often referred to as an indirect link or indirect path.

Since the remote UE device and the relay UE device are not assumed to be static, the PC5 link between the remote UE device and the relay UE device may change over time. This is also true for the Uu link between the remote UE device and the gNB. However, it is also possible that the remote UE device may move from in-coverage to out-of-coverage of the gNB, in which case a path switch may be performed to switch the remote UE device from the direct path (directly connected to the gNB via the Uu link) to the indirect path, assuming a relay UE device is available.

Although the techniques discussed herein may be applied to various types of systems and communication specifications, the devices of the example operate in accordance with at least one revision of the 3^{rd} Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D is employed. More specifically, the techniques may be applied to current and future releases of 3GPP NR specifications. For example, the techniques may also be applied to 3GPP NR (3GPP Rel-17) and 3GPP Rel-18.

In Rel-17, the remote UE device may only have one path towards the gNB. However, in Rel-18, multipaths are supported, which means that both the direct path and the indirect path can be supported simultaneously to improve robustness. This also means when one path experiences radio link failure (RLF) or when a connection establishment issue arises during path switch, the other existing path can still be relied on for making adjustments to the path switch without significant impact to the ongoing service.

Typically, in legacy non-relay cases, as part of the HO (handover) procedure from a source cell to a target cell, the UE sends measurement reports to the gNB based on configured event thresholds. In response to receiving the measurement reports, the gNB sends a handover command (e.g., a Radio Resource Control (RRC) Reconfiguration Message with Sync) to the UE to instruct the UE to connect to a target cell designated in the handover command. Within the network, it is assumed that the source cell would have already prepared the target cell with the information about the UE (including the UE's context).

This HO procedure is generally the same even when the remote UE device is instructed by the gNB to perform a path switch from the direct path to the indirect path. In this case, the remote UE device would send a measurement report to the gNB via the direct path. Based on the measurement report, the gNB may configure the remote UE device to perform a path switch to a designated relay UE device.

The gNB would also need to configure the relay UE device with information about the remote UE device as part of this path switch procedure. This is straightforward if the relay UE device is in the RRC CONNECTED state with the gNB. However, the target relay UE device is not required to be in the RRC CONNECTED state. Instead, the target relay UE device may be in the RRC IDLE or the RRC INACTIVE state, in which case the relay UE device will need to perform its own RRC connection to the gNB once the remote UE device is PC5 connected to the relay UE device. Once the PC5 link between the UE devices is established, the remote UE device sends an RRCReconfigurationComplete message, which is a Uu message intended for the gNB, to the relay UE device over the PC5 link. The relay UE device forwards the RRCReconfigurationComplete message to the gNB once the relay UE device's own Uu connection to the gNB is established.

There are two issues that may occur during the path switch from direct path to indirect path. First, if the target relay UE device chosen by the gNB is still in the RRC IDLE or RRC INACTIVE, the relay UE device must request RRC establishment with the gNB once the remote UE device is PC5 connected to the relay UE device and sends the RRCReconfigurationComplete message to the relay UE device. However, a problem arises if the relay UE device's RRC establishment request fails or is rejected by the gNB, since the gNB may not know that the relay UE device's establishment request is for the remote UE device (e.g., there is no special establishment cause for the relaying operation).

Second, if the target relay UE device is in the RRC IDLE or RRC INACTIVE state when the remote UE device selects the relay UE device for the path switch, it is possible that the target relay UE device may have reselected to a different cell (e.g., different from the cell the relay UE device camped on when it was included in the remote UE device's measurement report sent to the gNB). In Rel-17, path switch from direct to indirect is only supported when the cell on which the relay UE device is camped (e.g., connected) is the same as the cell on which the remote UE device is camped (e.g., via direct path to the gNB), which means that no inter-cell coordination is needed in Rel-17. Therefore, if the relay UE device reselected to another cell during the HO process, service continuity cannot take place seamlessly, and the remote UE device may need to perform RRC Reestablishment or Resume instead.

The examples set forth herein are directed towards addressing these two issues. In some of the examples described herein, a base station transmits, to a remote UE device over a direct Uu communication link, an RRC Reconfiguration Message with Sync identifying a target relay UE device and explicitly or implicitly identifying a cell for reselection by the target relay UE device. The identified cell is provided by the base station, and the remote UE device is connected to the cell. The remote UE device transmits, to the target relay UE device over a PC5 communication link, a PC5-RRC Message indicating the identified cell is the target cell. In response to receiving the PC5-RRC Message, the target relay UE device performs a cell reselection procedure that prioritizes the identified cell.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

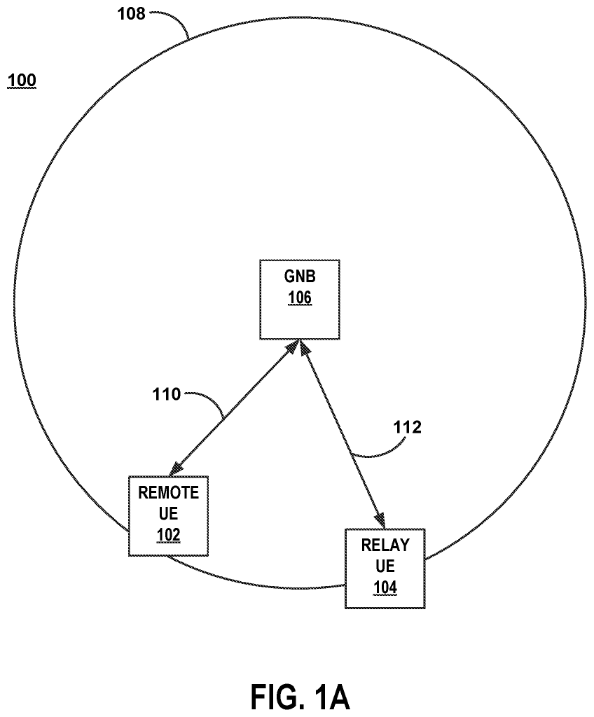

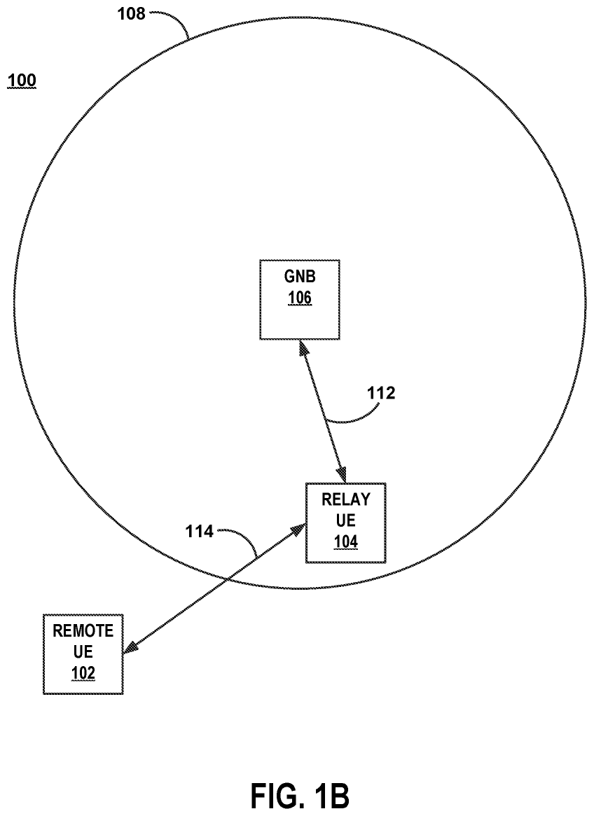

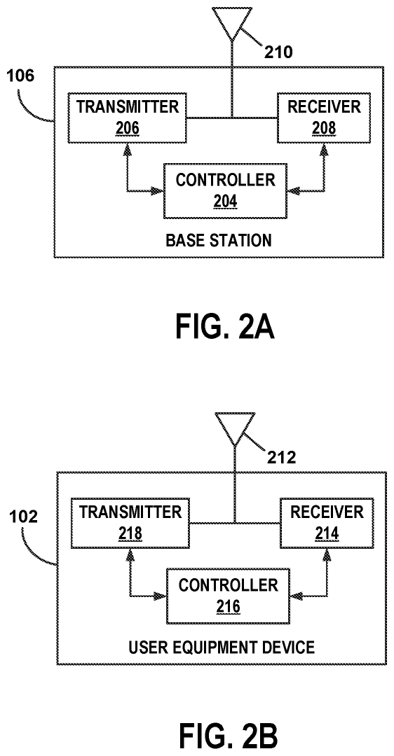

FIG. 1A is a block diagram of an example of a system 100 in which a remote user equipment (UE) device is directly communicating with a base station. In the interest of brevity, FIG. 1A only depicts one remote UE device 102 and one relay UE device 104. However, any number of remote UE devices and relay UE devices may be utilized, in other examples. As shown in FIG. 2B, user equipment device (UE) 102 comprises controller 216, transmitter 218, receiver 214, and antenna 212, as well as other electronics, hardware, and software code. Remote UE device 102 may also be referred to herein as a remote UE or as a remote wireless communication device (WCD). UE 102 is wirelessly connected to a radio access network (not shown) via base station 106, which provides various wireless services to UE 102. For the example shown in FIG. 1A, UE 102 operates in accordance with at least one revision of the 3rd Generation Partnership Project 5G New Radio (3GPP 5G NR) communication specification. In other examples, UE 102 may operate in accordance with other communication specifications. For the example shown in FIG. 1A, both of the UEs have the same components, circuitry, and configuration as UE 102 from FIG. 2B. However, either of the UEs in FIG. 1A may have components, circuitry, and configuration that differ from UE 102, in other examples.

UE 102 is any fixed, mobile, or portable equipment that performs the functions described herein. The various functions and operations of the blocks described with reference to UE 102 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In the interest of clarity and brevity, only one base station is shown in FIG. 1A. However, in other examples, any suitable number of base stations may be utilized. In the example of FIG. 1A, base station 106 provides wireless services to UEs within coverage area 108. Although not explicitly shown, coverage area 108 may be comprised of multiple cells. For the example shown in FIG. 1A, base station 106, sometimes referred to as a gNodeB or gNB, can receive uplink messages from UE devices and can transmit downlink messages to the UE devices.

Base station 106 is connected to the network through a backhaul (not shown) in accordance with known techniques. As shown in FIG. 2A, base station 106 comprises controller 204, transmitter 206, receiver 208, and antenna 210 as well as other electronics, hardware, and code. Base station 106 is any fixed, mobile, or portable equipment that performs the functions described herein. The various functions and operations of the blocks described with reference to base station 106 may be implemented in any number of devices, circuits, or elements. Two or more of the functional blocks may be integrated in a single device, and the functions described as performed in any single device may be implemented over several devices.

For the example shown in FIG. 2A, base station 106 may be a fixed device or apparatus that is installed at a particular location at the time of system deployment. Examples of such equipment include fixed base stations or fixed transceiver stations. In some situations, base station 106 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 106 may be a portable device that is not fixed to any particular location. Accordingly, base station 106 may be a portable user device such as a UE device in some circumstances.

Controller 204 includes any combination of hardware, software, and/or firmware for executing the functions described herein as well as facilitating the overall functionality of base station 106. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 106 in accordance with one of a plurality of modulation orders.

For the example shown in FIG. 1A, base station 106 and remote UE device 102 are connected by Uu link 110, which is the radio interface between a base station and a UE device. Thus, in the example shown in FIG. 1A, remote UE device 102 is connected via a direct path to base station 106. Base station 106 and relay UE device 104 are connected by Uu link 112 when relay UE device 104 is in an RRC CONNECTED state with base station 106. However, remote UE device 102 and relay UE device 104 do not have a direct connection between them in the example shown in FIG. 1A.

FIG. 1B is a block diagram of an example of the system of FIG. 1A in which the remote UE device has transitioned to indirectly communicating with the base station via a relay UE device. Thus, FIG. 1B depicts system 100 once remote UE device 102 switches from communicating with base station 106 via a direct path to an indirect path, as described herein. In the example shown in FIG. 1B, remote UE device 102 and relay UE device 104 are connected by PC5 link 114, which is an interface that allows UEs to communicate directly with each other over a direct channel. Other suitable types of communication links may be utilized in system 100, in other examples.

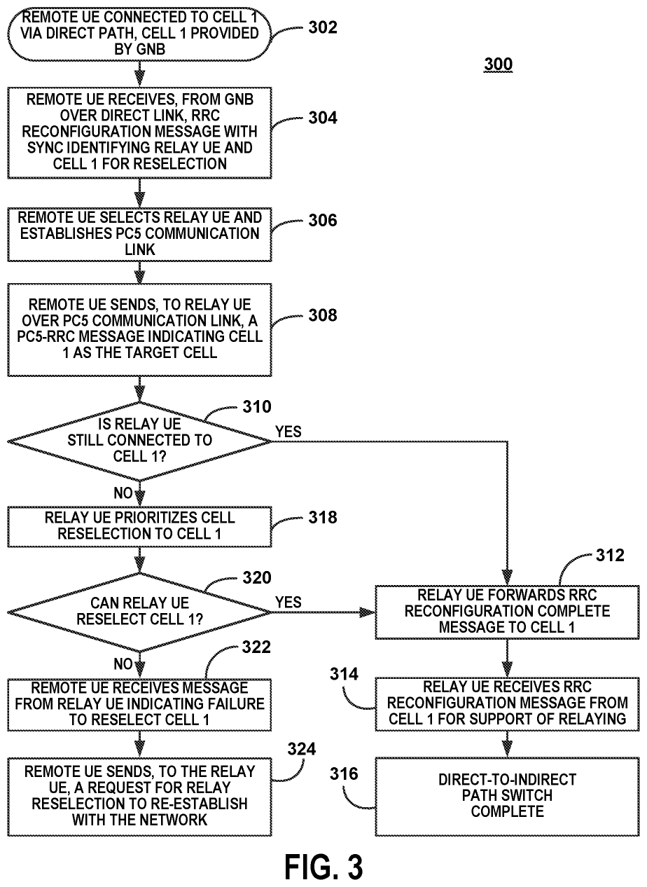

In operation, remote UE device 102 is directly communicating with base station 106 via Uu link 110, as shown in the example of FIG. 1A. However, as remote UE device 102 moves farther away from base station 106 as shown in FIG. 1B, the quality of Uu communication link 110 begins to worsen, which is a trigger for a direct-to-indirect path switch, in some examples. An example of the events that occur within system 100 during a direct-to-indirect path switch are reflected in FIG. 3, which is a flow chart of an example of a method of managing path switching from direct to indirect communication links. FIG. 3 begins at step 302 with remote UE device 102 directly connected, via Uu communication link 110, to a cell (e.g., Cell 1) provided by base station 106.

In some examples, remote UE device 102 is configured by base station 106 with one or more measurement events that will trigger remote UE device 102 to measure, via its antenna 212 and receiver 214, the quality of Uu communication link 110. In some examples, remote UE device 102 will send a measurement report regarding the quality of Uu communication link 110 to base station 106.

For the example shown in FIG. 1A, once the quality of Uu communication link 110 is below a threshold, remote UE device 102 utilizes its transmitter 218 and antenna 212 to transmit a measurement report to base station 106. The measurement report indicates that the quality of Uu communication link 110 is below the threshold. In some examples, the threshold is associated with threshold configuration information received at remote UE device 102 from base station 106.

In some examples, the measurement report is based on signal measurements of discovery messages received at remote UE device 102 from candidate relay UE devices. In further examples, when remote UE device 102 provides a measurement report to base station 106 to identify the candidate relay UE devices, the measurement report includes the cell identifiers (e.g., Cell IDs) of the cells on which each of the candidate relay UE devices are camped, respectively. Thus, in these examples, base station 106 uses the measurement report to determine which relay UE device should be the target relay UE device (e.g., preferably a relay UE device that is connected to the same cell to which the remote UE device is connected).

Base station 106 receives the measurement report via antenna 210 and receiver 208. In some examples, base station 106 transmits, in response to receiving the measurement report, to remote UE device 102 via Uu communication link 110, an RRC Reconfiguration Message with Sync identifying relay UE device 104 as a target relay UE device and explicitly or implicitly identifying a cell for reselection by the target relay UE device. The identified cell for reselection (1) is provided by base station 106, and (2) is the same cell to which remote UE device 102 is connected (e.g., camped on). Thus, in these examples, the source cell and the target cell are the same cell for the direct-to-indirect path switch for remote UE device 102.

In some examples, base station 106 explicitly identifies the cell for reselection (e.g., via a Cell ID included with the RRC Reconfiguration Message with Sync). In other examples, base station 106 does not explicitly identify the cell for reselection. In these other examples, remote UE device 102 is implicitly aware that base station 106 assumes that the cell for reselection is the same as the source cell to which remote UE device 102 is connected. This is currently how the process occurs for systems operating in accordance with 3GPP Rel-17, which only allows intra-gNB path switch. Thus, in some examples, base station 106 implicitly identifies, via the absence of an identification of a cell for reselection in the RRC Reconfiguration Message with Sync, the cell for reselection as being the same as the source cell to which remote UE device 102 is connected. However, in systems that operate in accordance with Rel-18, inter-gNB path switch is allowed, which would require that base station 106 identifies the cell for reselection since the cell for reselection could be different than the source cell.

Remote UE device 102 receives, via its antenna 212 and receiver 214, the RRC Reconfiguration Message with Sync identifying relay UE device 104 as the target relay UE device and explicitly or implicitly identifying the cell for reselection by the target relay UE device. The explicit identification of the cell refers to an actual identification of the cell (e.g., Cell ID) contained within the RRC Reconfiguration Message with Sync. The implicit identification of the cell refers to the fact that, if the RRC Reconfiguration Message with Sync does not explicitly identify the cell for reselection, remote UE device 102 should utilize the cell to which remote UE device 102 is connected as the cell for reselection.

Reception of the RRC Reconfiguration Message with Sync by remote UE device 102 is reflected at step 304 in FIG. 3. In response to receiving this message, remote UE device 102 requests to establish PC5 communication link 114 with relay UE device 104. Step 306 of FIG. 3 reflects remote UE device 102 selecting relay UE device 104 and establishing PC5 communication link 114 with relay UE device 104.

Once PC5 communication link 114 is established, remote UE device 102 transmits, to relay UE device 104 over PC5 communication link 114, a PC5-RRC Message indicating that the cell, which was identified in the RRC Reconfiguration Message with Sync as a cell for reselection, is a target cell. Step 308 of FIG. 3 reflects remote UE device 102 transmitting, to relay UE device 104 over PC5 communication link 114, a PC5-RRC Message indicating the cell (e.g., Cell 1) as the target cell. In some examples, remote UE device 102 also transmits, to relay UE device 104 over PC5 communication link 114, an RRC Reconfiguration Complete Message directed to base station 106 and indicating the cell is the target cell.

Relay UE device 104 receives, via its antenna 212 and receiver 214, the PC5-RRC Message from remote UE device 102. At step 310 of FIG. 3, a determination is made regarding whether relay UE device 104 is still connected to Cell 1. If relay UE device 104 is still connected to (e.g., camped on) the cell identified in the received PC5-RRC Message, relay UE device 104 will forward the RRC Reconfiguration Complete Message received from remote UE device 102 to base station 106. Step 312 of FIG. 3 reflects that relay UE device 104 is still connected to Cell 1 such that relay UE device 104 forwards the RRC Reconfiguration Complete Message to Cell 1.

In response to the forwarded RRC Reconfiguration Complete Message, base station 106 transmits an RRC Reconfiguration Message to relay UE device 104 configuring relay UE device 104 to support relaying between base station 106 and remote UE device 102. Step 314 of FIG. 3 reflects relay UE device 104 receiving an RRC Reconfiguration Message from Cell 1 for support of relaying. At this point, the direct-to-indirect path switch of remote UE device 102 is complete, which is reflected by step 316 of FIG. 3.

In the examples in which relay UE device 104 is no longer connected to (e.g., camped on) the cell identified in the PC5-RRC Message received from remote UE device 102, relay UE device 104 utilizes its controller 216 to perform a cell reselection procedure that prioritizes the cell identified in the PC5-RRC Message. Step 318 of FIG. 3 reflects that relay UE device 104 is no longer connected to Cell 1 and that relay UE device 104 prioritizes Cell 1 during a cell reselection procedure.

At step 320 of FIG. 3, a determination is made regarding whether relay UE device 104 can reselect to Cell 1. If relay UE device 104 is able to reselect to the cell identified in the PC5-RRC Message, relay UE device 104 will forward an RRC Reconfiguration Complete Message received from remote UE device 102 to base station 106. Step 312 of FIG. 3 reflects that relay UE device 104 was able to reselect to Cell 1 and that relay UE device 104 forwards the RRC Reconfiguration Complete Message to Cell 1.

In response to the forwarded RRC Reconfiguration Complete Message, base station 106 transmits an RRC Reconfiguration Message to relay UE device 104 configuring relay UE device 104 to support relaying between base station 106 and remote UE device 102. Step 314 of FIG. 3 reflects relay UE device 104 receiving the RRC Reconfiguration Message from Cell 1 for support of relaying. At this point, the direct-to-indirect path switch of remote UE device 102 is complete, which is reflected by step 316 of FIG. 3.

However, if relay UE device 104 is unable to reselect to the cell identified in the PC5-RRC Message, relay UE device 104 transmits, to remote UE device 102, a message indicating that relay UE device 104 failed to reselect the cell identified in the PC5-RRC Message. Step 322 of FIG. 3 reflects that relay UE device 104 was unable to reselect to Cell 1 and that relay UE device 104 transmits a message to remote UE device 102 indicating the failure to reselect to Cell 1.

In some examples, the message indicating that relay UE device 104 failed to reselect the cell is another PC5-RRC Message. In other examples, the message indicating that relay UE device 104 failed to reselect the cell is a Discovery message that includes a cell identifier (ID) indicating another cell to which the relay UE device 104 is connected. In further examples, the message indicating that relay UE device 104 failed to reselect the cell is a PC5-S message with a release indicator to release a unicast connection between relay UE device 104 and remote UE device 102. Regardless of the type of message used to indicate that relay UE device 104 failed to reselect the identified cell, PC5 communication link 114 is released after relay UE device 104 fails to reselect the identified cell.

In some examples, in response to receiving the message indicating that relay UE device 104 failed to reselect the identified cell, remote UE device 102 transmits, via its transmitter 218 and antenna 212, a request for relay reselection to relay UE device 104. Step 324 of FIG. 3 reflects remote UE device 102 sending the request for relay reselection to relay UE device 104. In some examples, the request for relay reselection is an RRC Re-Establishment Request message. Thus, in these examples, remote UE device 102 requests to reconnect to the same relay UE device 104 to which it was previously connected, in an attempt to perform RRC Re-establishment to the network via relay UE device 104.

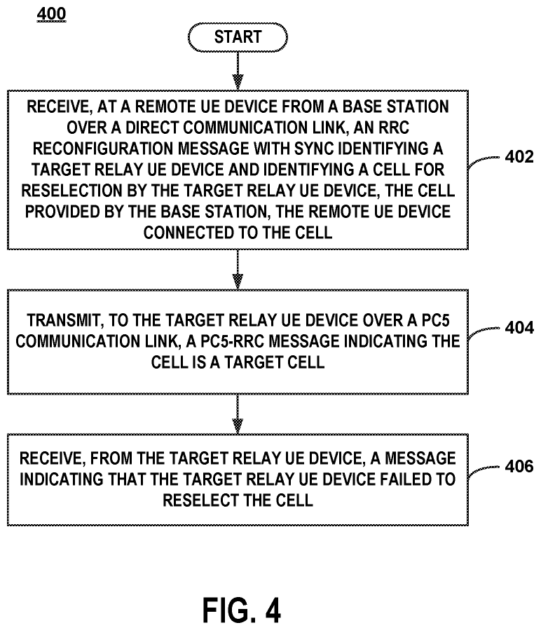

FIG. 4 is a flow chart of an example of a method performed at a remote UE device of managing path switching from direct to indirect communication links. The method is performed by a UE device that is initially connected to a base station through a direct path. For the example, therefore, the method may be performed by remote UE device 102 connected to base station 106.

At step 402, remote UE device receives, from a base station over a direct Uu communication link, an RRC Reconfiguration Message with Sync identifying a target relay UE device and explicitly or implicitly identifying a cell for reselection by the target relay UE device. The identified cell for reselection (1) is provided by the base station, and (2) is the same cell to which the remote UE device is connected (e.g., camped on). Thus, in these examples, the source cell and the target cell are the same cell for the direct-to-indirect path switch for the remote UE device.

A step 404, remote UE device transmits, to the target relay UE device over a PC5 communication link, a PC5-RRC Message indicating that the cell, which was identified in the RRC Reconfiguration Message with Sync as a cell for reselection, is a target cell. In some examples, remote UE device also transmits, to relay UE device over the PC5 communication link, an RRC Reconfiguration Complete Message directed to the base station and indicating the cell is the target cell. At step 406, remote UE device receives, from the target relay UE device, a message indicating that the target relay UE device failed to reselect the cell identified in the PC5-RRC Message.

In other examples, one or more of the steps of method 400 may be omitted, combined, performed in parallel, or performed in a different order than that described herein or shown in FIG. 4. In still further examples, additional steps may be added to method 400 that are not explicitly described in connection with the example shown in FIG. 4.

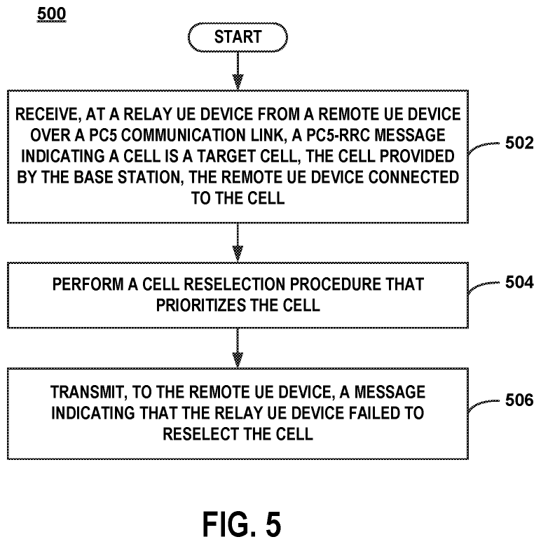

FIG. 5 is a flow chart of an example of a method performed at a relay UE device of managing path switching from direct to indirect communication links. The method is performed by a UE device that is the target relay UE device for a remote UE device performing a direct-to-indirect path switch. For the example, therefore, the method may be performed by relay UE device 104.

At step 502, the relay UE device receives, from a remote UE device over a PC5 communication link, a PC5-RRC message indicating a cell as a target cell. The identified cell (1) is provided by the base station, and (2) is the same cell to which the remote UE device is connected (e.g., camped on). Thus, in these examples, the source cell and the target cell are the same cell for the direct-to-indirect path switch for the remote UE device. In some examples, the relay UE device also receives, from the remote UE device over the PC5 communication link, an RRC Reconfiguration Complete Message directed to the base station and indicating the cell is the target cell.

A step 504, the relay UE device performs a cell reselection procedure that prioritizes the identified cell. At step 506, the relay UE device transmits, to the remote UE device, a message indicating that the relay UE device failed to reselect the cell identified in the PC5-RRC Message.

In other examples, one or more of the steps of method 500 may be omitted, combined, performed in parallel, or performed in a different order than that described herein or shown in FIG. 5. In still further examples, additional steps may be added to method 500 that are not explicitly described in connection with the example shown in FIG. 5.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A remote user equipment (UE) device comprising:
a receiver configured to receive, from a base station over a direct Uu communication link, a Radio Resource Control (RRC) Reconfiguration Message with Sync identifying a target relay UE device and identifying a cell for reselection by the target relay UE device, the cell provided by the base station, the remote UE device connected to the cell; and
a transmitter configured to transmit, to the target relay UE device over a PC5 communication link:
a PC5-RRC Message indicating the cell is a target cell, and
an RRC Reconfiguration Complete Message directed to the base station and indicating the cell is the target cell.

2. The remote UE device of claim 1, wherein the receiver is further configured to receive, from the target relay UE device, a message indicating that the target relay UE device failed to reselect the cell.

3. The remote UE device of claim 2, wherein the message indicating that the target relay UE device failed to reselect the cell is a PC5-RRC message.

4. The remote UE device of claim 2, wherein the message indicating that the target relay UE device failed to reselect the cell is a Discovery message that includes a cell identifier (ID) indicating another cell to which the target relay UE device is connected.

5. The remote UE device of claim 2, wherein the message indicating that the target relay UE device failed to reselect the cell is a PC5-S message with a release indicator to release a unicast connection between the target relay UE device and the remote UE device.

6. The remote UE device of claim 2, further comprising:
a controller configured to, in response to receiving the message indicating that the target relay UE device failed to reselect the cell, perform relay reselection.

7. A relay user equipment (UE) device comprising:
a receiver configured to receive, from a remote UE device over a PC5 communication link:
a PC5-Radio Resource Control (RRC) Message indicating a cell is a target cell, and
an RRC Reconfiguration Complete Message directed to a base station and indicating the cell is the target cell; and
a controller configured to perform a cell reselection procedure that prioritizes the cell.

8. The relay UE device of claim 7, wherein the target cell is provided by the base station.

9. The relay UE device of claim 7, further comprising:
a transmitter configured to transmit, to the remote UE device, a message indicating that the relay UE device failed to reselect the cell.

10. The relay UE device of claim 9, wherein the message indicating that the relay UE device failed to reselect the cell is a PC5-RRC message.

11. The relay UE device of claim 9, wherein the message indicating that the relay UE device failed to reselect the cell is a Discovery message that includes a cell identifier (ID) indicating another cell to which the relay UE device is connected.

12. The relay UE device of claim 9, wherein the message indicating that the relay UE device failed to reselect the cell is a PC5-S message with a release indicator to release a unicast connection between the relay UE device and the remote UE device.
